(19) United States
(12) Patent Application Publication
(10) Pub. No.: US 2019/0308856 A1
(43) Pub. Date: Oct. 10, 2019

(54) Robotic Multi-Directional Load Transport

(71) Applicant: Wright Sheds, LLC, Greenwood, NE (US)

(72) Inventor: Chad Wright, Lincoln, NE (US)

(73) Assignee: Wright Sheds, LLC, Greenwood, NE (US)

(21) Appl. No.: 16/376,771

(22) Filed: Apr. 5, 2019

Related U.S. Application Data
(60) Provisional application No. 62/654,029, filed on Apr. 6, 2018.

(51) Int. Cl. B66F 9/06; B65G 1/04; B62D 63/04; B66F 9/075

(52) U.S. Cl. CPC B66F 9/063; B65G 1/0492; B62D 63/04; G05D 2201/0216; B66F 9/07568; B66F 9/07572; B66F 9/07581

(57) ABSTRACT

A multi-directional transport system for transporting a heavy load that includes robotic units that act in synchronization to move a heavy object. The robotic units include an integration of system controls that allow the robotic units to communicate with each other and move in synchronization. The robotic units may be controlled remotely. The robotic units may be battery powered and the driving motor. The robotic unit may have an attachment point for secure attachment to the object.

### CROSS REFERENCE TO RELATED APPLICATION

This application claims priority under 35 U.S.C. § 119 to provisional application Ser. No. 62/654,029 filed Apr. 6, 2018, which is hereby incorporated by reference in its entirety.

### FIELD OF THE INVENTION

The present invention relates to transporting loads. More particularly, but not exclusively, the present invention relates to robotic multi-directional load transport system.

### BACKGROUND

Apparatuses for transporting loads are well known in the prior art. The current state of the prior art transporting heavy loads, such as gaylords, pallets, sheds, shipping containers, is done using a gas-powered fork lift device on one end of the load and two nonmotorized units on the corners of the opposite end, making it difficult to maneuver the heavy load in a space restricted area. Therefore, what is needed is robotic multi-directional transport system that moves a heavy load in a space restricted area by controlling robotic units remotely.

### SUMMARY

Therefore, it is a primary object, feature, or advantage of the present invention to improve over the state of the art.

It is a further object, feature, or advantage of the present invention to increase safety by using a remote device to control the transport of heavy loads into locales with limited space.

It is still a further object, feature, or advantage of the present invention to improve efficacy of transporting a load to its desired location by using multi-directional transport.

Another object, feature, or advantage is to decrease the amount of terrain damage while transporting the load.

One or more of these and/or other objects, features, or advantages of the present invention will become apparent from the specification and claims that follow. No single aspect need provide each and every object, feature, or advantage. Different aspects may have different objects, features, or advantages. Therefore, the present invention is not to be limited to or by any objects, features, or advantages stated herein.

A multi-directional transport system is described. In one aspect of the present invention, the multi directional system may include, for example, at least one robotic unit having at least one wheel with a rim and a ground contacting surface connected to the rim for transporting a load, an electrical drive actuator housed within the rim operable configured to drive the rim and a a load bearing frame secured to the rim. The system may include a control system operably connected to the robotic unit.

The robotic unit may be further comprised of additional wheels attached to an axle or the load bearing frame. The axle may be attached to the rim and the load bearing frame. The robotic unit may further be comprised of an electric steering motor actuator configured to drive the robotic unit. The robotic unit may further include a thrust bearing. The thrust bearing may be attached to the top of the load bearing frame and an attachment point configured to attach the robotic unit to the heavy load. The robotic unit may be further comprised of an electrical lift actuator allowing the robotic unit to lift and lower the heavy load. The communication unit may further comprise a remote device configured for wired or wireless communication with the robotic unit. The robotic unit may contain one or more sensors. The robotic unit may further include an electronics drawer configured to store one or more electrical components and a battery.

In additional aspects of the present invention the multi-directional transport system may use more than one robotic unit to transport the heavy load controlled by the same remote device.

Each of the robotic units may have one or more wheels attached to load bearing frame. The use of multiple robotic units allows for better weight distribution while transporting the heavy load.

In another aspect of the present invention, the robotic unit connects with the remote device once the robotic units are turned on. Every time a robotic unit connects with the remote device, the control system, synchronizes the newly added robotic unit with the existing robotic units already connected to the remote device, allowing the robotic units to move in unison.

In another aspect of the multi-direction transport system, four robotic units are used to transport the heavy load. Each robotic unit may include at least a wheel to transport the load. The robotic unit may have an electronic steering module and a drive module that responds to commands given by the remote device and the robotic unit gives feedback received from the sensors to the remote device. The electronic steering module may receive commands from the remote device and send commands to the drive module which rotates the wheel of the robot unit or units. The four robotic units may be designed to move in synchronization with each other while transporting the load to the desired location.

According to one aspect of the present invention, the multi-direction transport system is configured to operate four robotic units to transport the load. Each robotic unit may include at least three wheels. One of the wheels may be smaller than the other two. The robotic unit may have an electronic steering module and an electronic drive module that responds to commands given by the remote device and the robotic unit gives feedback received from the sensors to the remote device. The electronic steering module may receive commands from the remote device and send commands to the drive module which rotates the wheels of the robot unit or units. The four robotic units may be designed to move in synchronization with each other while transporting the load to the desired location.

In another aspect of the present invention, the multi-direction transport system is configured to operate four robotic units, each of the robotic units may include at least two wheels, to transport the load. Each robotic unit may have a steering module and an electronic drive module that responds to commands given by the remote device and the robotic unit gives feedback received from the sensors to the remote device. The electronic steering module may receive commands from the remote device and send commands to the steering module which rotates the wheel of the robot unit or units. The four robotic units may be designed to move in synchronization with each other while transporting the load to the desired location.

In another aspect of the present invention, multi-direction transport system may be configured with four robotic units, wherein each unit includes four wheels, to transport the load. The robotic unit has an steering module and an drive module that responds to commands given by the remote device and the robotic unit gives feedback received from the sensors to the remote device. The steering module may receive commands from the remote device and send commands to the system which rotates the wheel of the robot unit or units. The four robotic units may be designed to move in synchronization with each other while transporting the load to the desired location.

In alternative aspects of the present invention, the robotic multi-directional transport system, can be configured with one robotic unit, controlled by the remote device, and used to transport the load in the front of the load while one or more non-robotic units are used to aid in transporting the moving object. In another aspect, two robotic units, controlled by a remote device, may be used while transporting the load along with one or more nonrobotic units. The two robotic units may be designed to move in synchronization with each other while transporting the load to the desired location. In other aspects, one robotic unit may be the master unit and the at least one other robotic unit and or nonrobotic units may be slave units. In yet another alternative aspect at least one robotic unit may be used with at least one electric pulley.

In additional aspects of the present invention the multi-directional transport system may use more than four robotic units to transport the heavy load controlled by the same remote device. The robotic units may have one or more wheels attached to the load bearing frame or an axle. The use of multiple robotic units allows for better weight distribution while transporting the heavy load.

A method for moving objects using a multi-directional transport system may include providing at least one robotic unit to transport the moving object, wherein the robotic unit further comprises a wheel having a rim and a ground contacting surface connected to the rim for transporting a load, an electrical actuator housed within a load bearing frame configured to drive the rim and ground contacting surface. The robotic unit may be further comprised of a load bearing frame secured to the rim and a control system operably connected to the robotic unit. The method can also include attaching the robotic unit to an underside of a heavy object, communicating electronic commands from a remote device to the at least one robotic unit and actuating the electrical actuator with the electronic commands to operably drive the rim for transporting the object.

### BRIEF DESCRIPTION OF THE DRAWINGS

Illustrated aspects of the disclosure are described in detail below with reference to the attached drawing figures, which are incorporated by reference herein, wherein:

FIG. 1 is a view of the preferred aspect robotic multi-directional transportation system carrying a load;

FIG. 2 is a view of the one aspect of one robotic unit;

FIG. 3 is another view of one aspect of one robotic unit;

FIG. 4 is an illustration of one aspect of the base portion of the robotic unit;

FIG. 5 is a view of one aspect of the steering motor;

FIG. 6 is a view of one aspect of the electrical actuator;

FIG. 7 is a view of one aspect of the electric lift acuator;

FIG. 8 is a view of one aspect of the remote device;

FIG. 9 is a view of one aspect of the control system;

FIG. 10 is a view of one aspect of the method for transporting heavy objects;

FIG. 11 is a view of another aspect of the method for transporting heavy objects; and

FIG. 12 is a view of another aspect of the robotic unit.

### DETAILED DESCRIPTION

The present invention is directed to a novel method and system for multi-directional transport of heavy objects or loads by directing robotic units with a remote device to transport the heavy object to a desired location. The present invention finds applicability to the transportation of heavy loads to a desired location with little to no terrain damage or moving the heavy load into or through space restricted areas. The present multi-directional transportation system has the ability to move forward, backward and turn while transporting the load up and down different grades and terrain.

One aspect of the multi-directional load transport system may include a multi-directional transport system for moving heavy objects comprising at least one robotic unit. The multi-directional transport system may further include a control system operably connected to the robotic unit, the control system configured to provide one or more operational commands to the at least one robotic unit. The robotic unit may be comprised of at least one wheel having a ground contacting surface and a rim supporting the ground contacting surface. The wheel may further be comprised of a drive module. The drive module may include a driving motor operatively attached to the wheel and operably configured to rotate the wheel. The drive module may further include an electrical actuator operably configured to rotate the wheel. The wheel may include a steering module further comprised of a steering motor operatively attached to the wheel and operatively configured to turn the wheel relative to a load bearing frame secured to the wheel. The steering module may be further comprised of an electrical steering actuator operably configured to turn the wheel relative to the load bearing frame.

Another aspect of the multi-directional load transport system may include a multi-directional transport system for moving heavy objects comprising at least one robotic unit. The multi-directional transport system may further include a control system operably connected to the robotic unit, the control system configured to provide one or more operational commands to the at least one robotic unit. The robotic unit may be comprised of at least one wheel having a ground contacting surface, a rim supporting the ground contacting surface. The robotic unit may have an axle for securing the wheel to a load bearing frame. The axle may be comprised of a drive module. The drive module may include driving motor operatively attached to the wheel and operably configured to rotate the wheel. The drive module may further include an electrical actuator operably configured to rotate the wheel. The axle may include a steering module further comprised of a steering motor operatively attached to the wheel and operatively configured to turn the wheel relative to a load bearing frame secured to the axle. The steering module may be further comprised of an electrical steering actuator operably configured to turn the wheel relative to the load bearing frame.

An additional aspect of the multi-directional load transport system may include a multi-directional transport system for moving heavy objects comprising at least one robotic unit. The multi-directional transport system may further include a control system operably connected to the robotic unit, the control system configured to provide one or more operational commands to the at least one robotic unit. The robotic unit may be comprised of a wheel having a ground contacting surface, a rim supporting the ground contacting surface. The robotic unit may also include a load bearing frame secured to the at least one wheel. The load bearing frame may be comprised of a drive module. The drive module may include a driving motor operatively attached to the wheel and operably configured to rotate the wheel. The drive module may further include an electrical actuator operably configured to rotate the wheel. The load bearing frame may include a steering module further comprised of a steering motor operatively attached to the wheel and operatively configured to turn the wheel relative to the load bearing frame. The steering module may be further comprised of an electrical steering actuator operably configured to turn the wheel relative to the load bearing frame.

An additional aspect of the multi-directional load transport system may include a multi-directional transport system for moving heavy objects comprising at least one robotic unit. The multi-directional transport system may further include a control system operably connected to the robotic unit, the control system configured to provide one or more operational commands to the at least one robotic unit. The robotic unit may be comprised of two wheels, each having a ground contacting surface and a rim supporting the ground contacting surface. The robotic unit may also include a load bearing frame secured to the two wheels. The load bearing frame may be further comprised of a drive module. The drive module may include a driving motor operatively attached to the wheel and operably configured to rotate the wheels. The drive module may further include at least one driving motor operably configured to rotate the wheels. The load bearing frame may include a steering module further comprised of a steering motor operatively attached to the wheels and operatively configured to turn the wheel relative to the load bearing frame. The steering module may be further comprised of an electrical steering actuator operably configured to turn the wheels relative to the load bearing frame.

An alternative aspect of the multi-directional load transport system may include a multi-directional transport system for moving heavy objects comprising at least one robotic unit. The multi-directional transport system may include a control system operably connected to the robotic unit, the control system configured to provide one or more operational commands to the at least one robotic unit. The robotic unit may be comprised of a wheel having a ground contacting surface, a rim supporting the ground contacting surface. The wheel may further be comprising of a drive module. The drive module may include a driving motor operatively attached to the wheel and operably configured to rotate the wheel. The drive module may further include an electrical actuator operably configured to rotate the wheel. The robotic unit may have an axle for securing the wheel to a load bearing frame. The load bearing frame or the axle may include a steering module further comprised of a steering motor operatively attached to the wheel and operatively configured to turn the wheel relative to a load bearing frame secured to the wheel. The steering module may be further comprised of an electrical steering actuator operably configured to turn the wheel relative to the load bearing frame.

Another additional aspect of the multi-directional load transport system may include a multi-directional transport system for moving heavy objects comprising at least one robotic unit. The multi-directional transport system may include a control system operably connected to the robotic unit, the control system configured to provide one or more operational commands to the at least one robotic unit. The robotic unit may be comprised of a wheel having a ground contacting surface, a rim supporting the ground contacting surface. The wheel may further be comprising of a drive module. The drive module may include driving motor operatively attached to the wheel and operably configured to rotate the wheel. The drive module may further include an electrical actuator operably configured to rotate the wheel. The robotic unit may have an axle for securing the wheel to a load bearing frame. The load bearing frame or the axle may include a steering module further comprised of a steering motor operatively attached to the wheel and operatively configured to turn the wheel relative to a load bearing frame secured to the wheel. The steering module may be further comprised of an electrical steering actuator operably configured to turn the wheel relative to the load bearing frame. The robotic unit may include an interface module for communication between the drive module and the steering module.

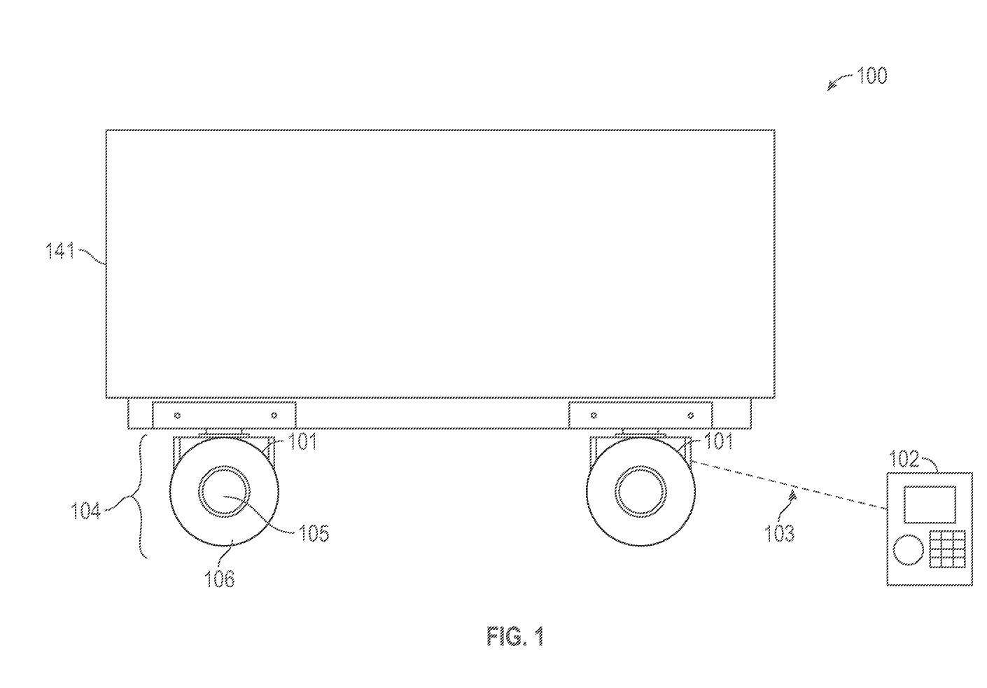

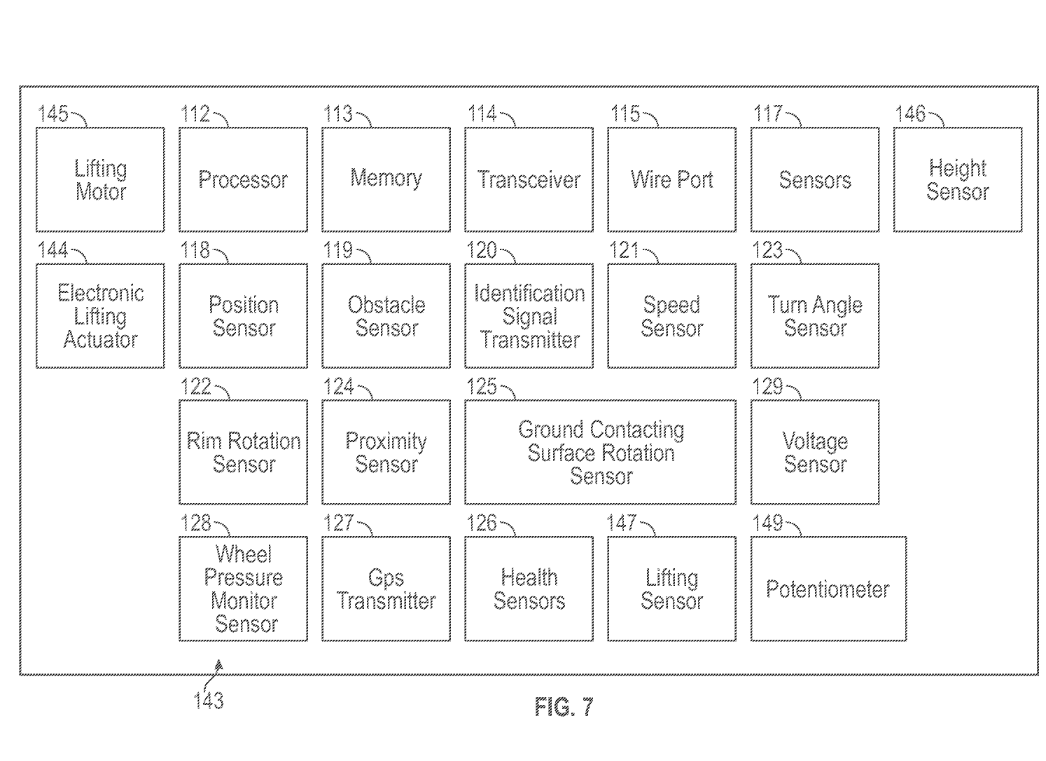

Referring to FIG. 1, a multi-directional load transport system 100 is shown in accordance with one aspect of the present invention. Multi-directional transport system 100 includes at least one robotic unit 101. The multi-directional transport system may be further comprised of a remote device 102 to send command signals to the at least one robotic unit 101 through a control system 103 as shown by FIG. 7. Multi-directional transport system 100 generally includes four robotic units positioned at each corner of the load. The use of four robotic units allows for better weight distribution, better traction, and better control of the multi-directional transport system 100. There is not intended to be a perceived difference between the robotic units as far as the terms front, back, left, and right are concerned. The robotic unit 101 is designed to move forward, backward and turn to allow delivery of a load to a desired to location with greater efficiency and less risk of injury. In one aspect of the present invention, the multi-directional transport system 100 is designed to handle grades of terrain up to 12 percent. In alternative aspects, the maximum grade of terrain the multi-directional transport system 100 may be higher or lower. In another aspect of the present invention, the multi-directional transport system 100 is designed to have a maximum ground clearance of 18 inches. In other aspects the maximum ground clearance may be higher or lower. In one aspect of the present invention, the multi-directional transport system 100 is designed to have a total force requirement of 16 kN, in another aspect the total force requirement may be 2160 lbf, in other aspects the total force requirement may be higher or lower. In one aspect of the present invention the total power requirement is 3.6 kW, in another aspect the total power requirement may be 2.88 hp, in other aspects the total power requirement may be higher or lower. In one aspect of the present invention the total work requirement is 730 W*hr, in another aspect the total work requirement may be 1.2×10⁵ lbf*ft, in other aspects the total work requirement may be higher or lower. In one aspect of the present invention, the total torque is 2400 N*m, in another aspect the torque requirement may be 1100 ft*lbf. The torque requirement may be higher or lower in alternative aspects. In one aspect of the present invention, robotic unit 101 is designed to have a carrying capacity of 2000 lbs. In other aspects, robotic unit 101 may be designed to have a greater carrying capacity or a lower carrying capacity. Robotic unit 101 is designed to maneuver over rough terrain allowing for more efficient and safer transport.

In one aspect of the present invention, a robotic unit 101 is placed in each of the corners of a flat-bottomed load. In other aspects, the robotic unit 101 may be placed in different locations on the bottom of a load 141 or to the left, right, front or back of the load. In one aspect the entire robotic unit 101 may be placed underneath the load 141. In other aspects only a small portion of robotic unit 101 is placed underneath the load. Robotic unit 101 may be designed to fit beneath the footprint of the heavy load 141 such as a car, shipping container or a hot tub. This allows the robotic unit 101 to maneuver through space restricted areas causing little to no damage to the heavy load 141 by remaining under the load. Robotic unit 101 may also be designed to lift the heavy load 141 without aid of other equipment or human aid. This advantage allows robotic unit 101 to lift a heavy load 141 in a space restricted area with little to no fear of injury.

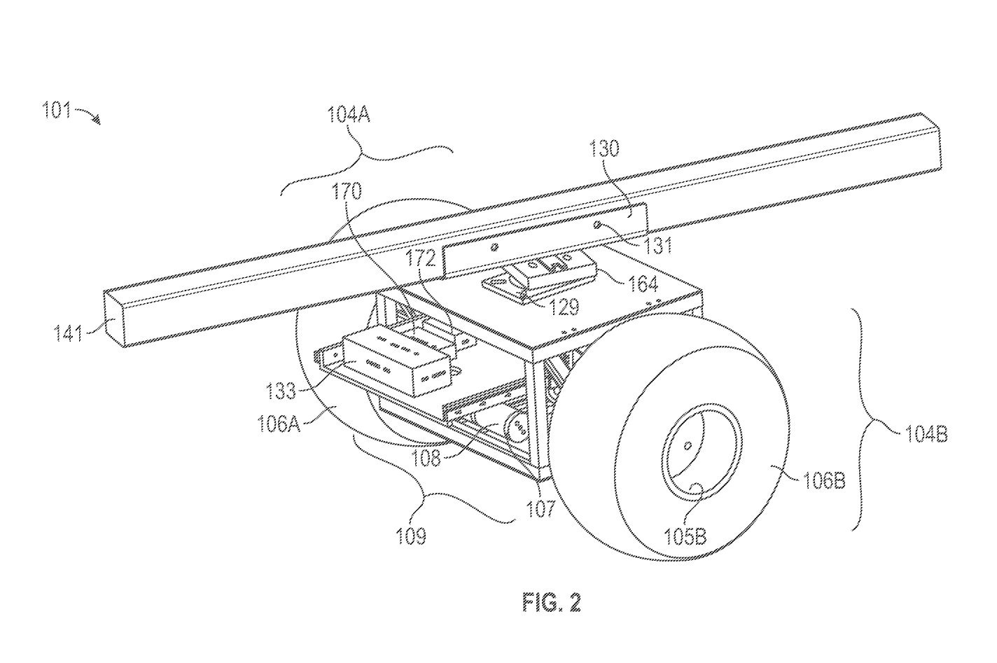

Referring to FIG. 2, one aspect of the robotic unit 101 in the present invention is shown. In one aspect of the present invention, robotic unit 101 comprises at least two wheels 104. In other aspects of the present invention, the robotic unit may contain a single wheel or at least three wheels. Wheel 104 may contain a rim 105 with a ground contacting surface 106 for transporting the heave load 141. The robotic unit may also contain a drive module 107. The drive module 107 may be operably configured to rotate wheel 104. The robotic unit 101 may include a steering module 108. Steering module 108 may be operably configured to steer wheel 104. In one aspect of the present invention the robotic unit may have a first wheel 104A having a first ground contacting surface 106A, a first rim 105A supporting the first ground contacting surface 106A and the second wheel 104B having a second ground contacting surface 106B, a second rim 105B supporting the second ground contacting surface 106B. A power source, such as a battery 133, is operably mounted and connected in electrical communication with motors 135A-B. The battery 133 is configured to power one or more computer, control boards or controllers 170, 172 for controlling operation of motors 135A-B.

Wheel 104 may be designed to move backward, turn and power forward and move left and right. In other aspects, wheel 104 may only move in certain directions such as forwards and backwards or right and left. In alternative aspects wheel 104 may be designed to turn 360 degrees allowing for greater maneuverability, greater efficiency, and less risk for injury. In other aspects the wheel 104 may be designed to turn using pinpoint turning, pivot turning or curved turning. In one aspect of the present invention, the ground contacting surface 106 may comprise a tire allowing for less terrain damage. In some aspects of the present invention the ground contacting surface 106 may be solid rubber tire. In one aspect of the present invention the ground contacting surface 106 may be comprised of a tire with a polyurethane fill for added strength. In addition, the polyurethane fill may lead to less flat tires. In alternative aspects, the ground contacting surface 106 may comprise continuous tracks, spoked wheels, over the tire tracks, studded tires, etc. The rim 105 may be comprised of at least a rim, spokes, a hub, or a hub cap.

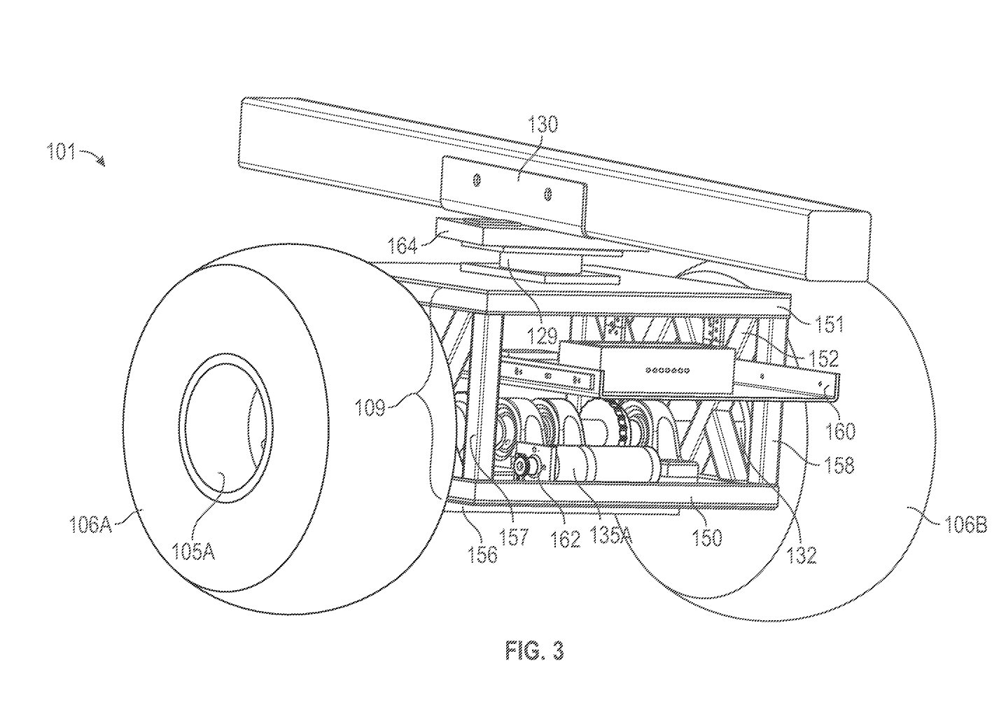

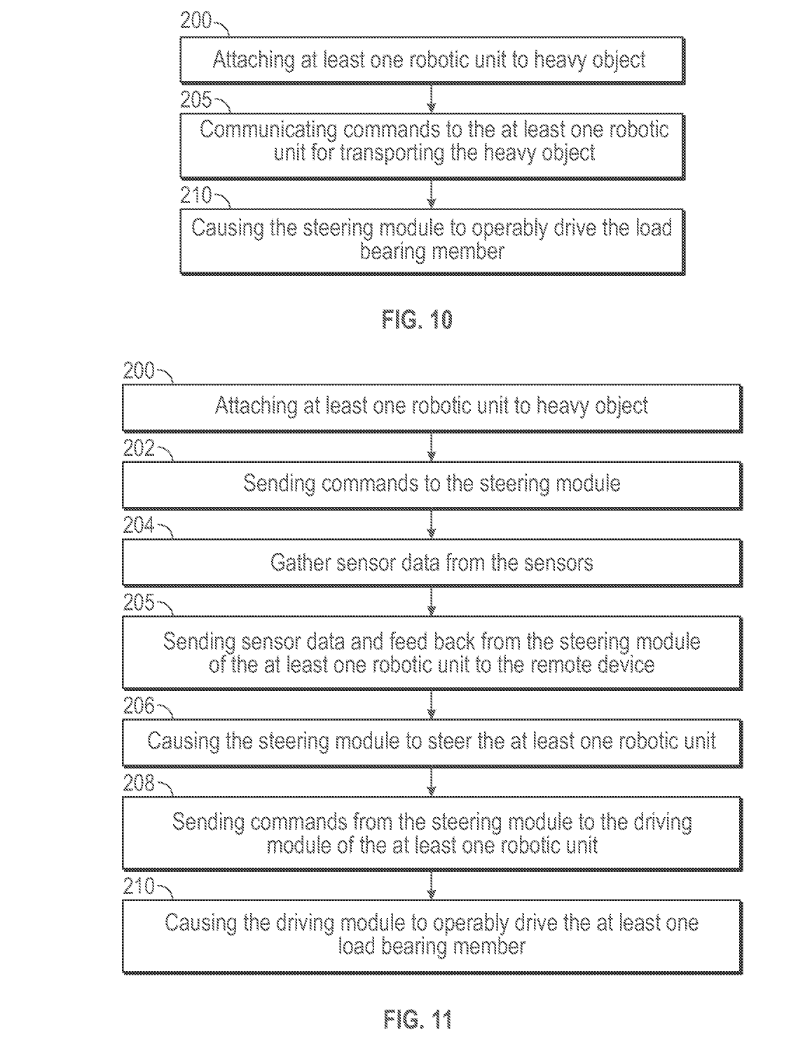

The rim 105 may be comprised of at least a rim, spokes, a hub, or a hub cap. The rim 105 may also be comprised of at least on electrical actuator 107 to rotate the ground contacting surface 106 and part of the rim 105. The rim 105 or the ground contacting surface 106 may also be connected to an axle 132 as shown in FIGS. 3 and 10. The axle 132 may be designed to carry 3000 lbf. In additional aspects of the present invention the load capacity of the axle 132 may be higher or lower. In some aspects of the present invention axle 132 may be comprised of steel shafts. In additional aspects of the present invention axle 132 may contain a slotted keyway for sprocket assembly. In another aspect of the present invention axle 132 may contain bearings securing axle 132 to the load bearing frame 109. In additional aspects of the present invention the axle 132 may be connected to the electrical actuation 107 by one or more mounting brackets. In one aspect of the present invention the axle 132 may be a single axle or a discontinuous axle. In an alternative aspect of the present invention the axle 132 may be a dual axle or an independent axle. In some aspects of the present invention the robotic unit 101 may have two or more axles.

The rim 105 may also contain a power source to power robotic unit 101. The power source may be a rechargeable battery 133. A few examples of a rechargeable battery are lithium iron phosphate battery, sealed lead acid battery, valve regulated lead acid battery, or AGM lead acid battery. The use of the battery for a power source allows the battery to fit inside the robot, handle high current. In the preferred aspect battery 133 uses trip power. Other power sources may include generators systems such as thermoelectric generators, fuel cells, hydraulics, super capacitors, solar energy or other energy harvesters. The ground contacting surface may further include lights allowing the robotic unit 101 to transport the heavy object 141 at night. In some aspects of the present invention, the robotic unit 101 has a power button, switch, dial or key for turning the robotic unit on or off. In alternative aspects of the present invention, other mechanisms for turning the robotic unit 101 on or off may be used.

In one aspect of the present invention, the robotic unit 101 may also contain a load bearing frame 109. The load bearing frame 109 may be secured to the axle 132. The load bearing frame 109 may be secured to the wheel 104. The robotic unit 101 may also have a control system 103 operably connected to the robotic unit. In some aspects of the present invention the load bearing frame 109 may contain a top portion 151 of the load bearing frame and a base portion 150 of the load bearing frame 109 connected by at least one or more welded cross members 154. In one aspect of the present invention the welded cross members are only located on a first side 157 and a second side 158 opposing the first side 157. In other aspects of the present invention, the load bearing frame may contain 4 side walls as shown by FIG. 3. In some aspects of the present invention the load bearing frame may protrude past the wheel 104.

The robotic unit 101 may also contain a steering module 108. In the preferred aspect, robotic unit 101 uses swerve steering allowing for low risk of terrain damage, high efficiency and high maneuverability. In alternative aspects, steering module 108 may be configured for drive wheels steering, allowing for durability and familiar controls. In additional aspects the steering module 108 may be configured for non-drive wheel steering for easier maintenance. In some aspects, the steering module 108 may be brushed. In other aspects, the steering module 108 may be brushless. In an alternative aspect robotic unit 101 may use an AC motor as the steering module 108. Some aspects of robotic unit 101 may include two-wheel drive (2WD) while other aspects of robotic unit 101 may have four-wheel drive (4WD). Additional aspects of the present invention may have all-wheel drive (AWD). Each robotic unit may also contain a drive shaft for transmitting torque and rotation, a transmission/gearbox. The steering module may be housed in the wheel 104, the load bearing frame 109 or the axle 132.

Each robotic unit may contain at least one thrust bearing 129. In one aspect of the present invention the thrust bearing 129 may contain one or more double direction thrust ball bearings. In additional aspects of the present invention the thrust bearing may contain a thrust bearing housing around the thrust bearing such as circular plates, a pipe, pipe sections, or a chassis. In one aspect of the present invention, the load bearing frame 109 may remain stationary while the load bearing support member 108 rotates turning the robotic unit 101. In alternative aspects, the entire robotic unit 101 may remain in the same position as the load bearing frame 109 while a small part of the rim 105 and the wheel 104 moves with a turning mechanism. In additional aspects of the present invention, the thrust bearing 129 may be designed to rotate freely or 360 degrees allowing differential steering of the robotic unit 101. In additional aspects of the present invention, the thrust bearing 129 must be able to handle axial and radial forces while the robotic unit is transporting the heavy load 141. In additional aspects of the present invention, the thrust bearing 129 may be designed to remain completely intact if the robotic unit 101 loses contact with the ground. In some aspects of the present invention, potentiometers 149 may be implemented into the thrust bearing housing. The thrust bearing 129 may be coupled to the load bearing frame 109.

The robot unit 101 will generally include or is linked to an attachment point 130 allowing the robot unit to be securely attached to the load 141. The attachment point 130 may be shaped similar to a U. In some aspects of the present invention the attachment point 130 may be a gauge tube. In one aspect of the present invention, the attachment point 130 is a screw clamp, allowing for greater stability and higher performance. In other aspects, attachment point 130 may be a through channel; vice clamp; a strapped corner mount; jaw clamp, C-clamp, F-clamp, parallel clamps, welded beam attachment that may be screwed into the long piece. The attachment point 130 may also be a modified clamp where one entire right or left side of the clamp slides along a bottom piece of the clamp being tightened or loosened by a screw. In another aspect one or both sides of the clamp may be undulated or tacked slowing sharp structures to go into the wood, giving the clamp more stability when attaching to the long piece under the load. The attachment point 130 may be designed as a pallet, fitting underneath the heavy load 141. The attachment point 130 may be forklift scissors. The attachment point may have a flat surface shaped as a triangle, square or rectangle, or any other shape that fits underneath the heavy load to provide greater stability while transporting the load 141. The load 141 such as a shed may contain a long piece such as a 2×4, 4×4, or 4×6 on the bottom of the load where the attachment point 130 securely attaches to the load 141. The long piece may be made of wood, aluminum, composite metal or other building materials. The long piece may be made of wood, aluminum, composite metal or other building materials. In some aspects of the present invention, the attachment point 130 may uses bolts, truss plates, plates with holes or expanded metal to securely grip the load 141.

The attachment point 130 may be designed as an electronic or hydraulic lift. The attachment point may include an electric jack designed to lift the heavy object 141. This use of an attachment point with lifting capabilities decreases the risk of injury. It also allows for the robotic unit 101 to lift the heavy object 141 in a space restricted area and lowering the heavy object in a space restricted area, where it would be difficult if other methods of lifting, transporting, and lowering heavy objects were used. In some aspects of the present invention, the attachment point 130 may be designed to carry the weight of the robot. This advantage allows the robot to stay in one piece in the event the robot is lifted off the ground while transporting the shed. In other aspects of the of the multi-directional transport system, the attachment point is designed to handle the sheer force of the moving robotic unit.

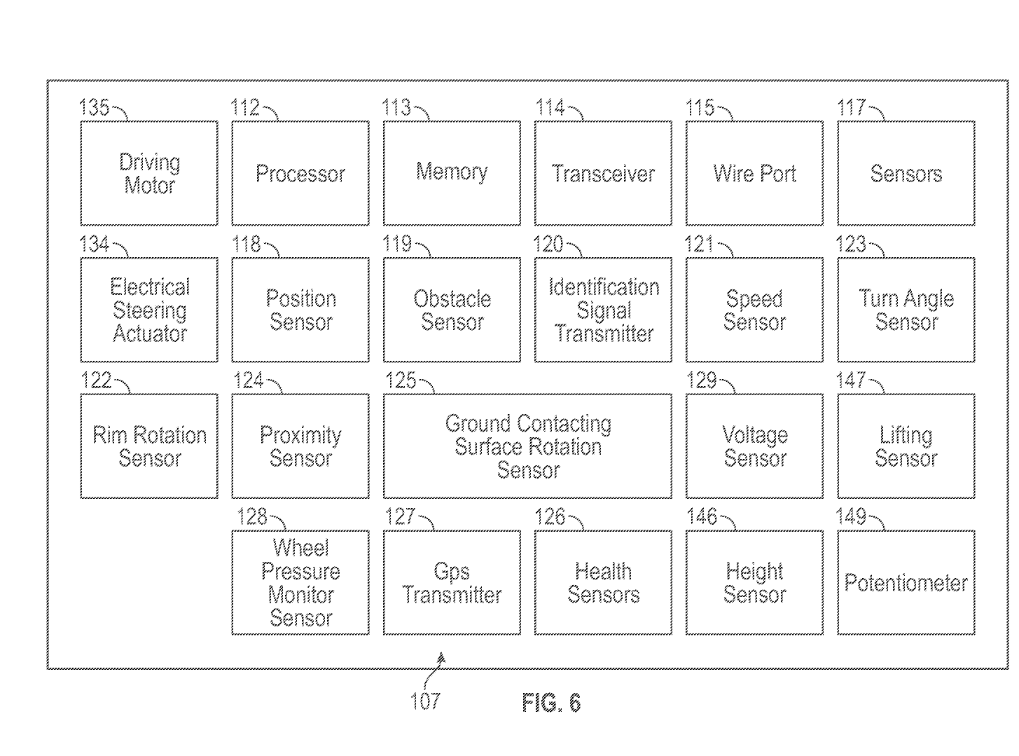

The robotic unit may also be designed to lift the heavy object 141 relative to wheel 104 to provide for greater safety while transporting the heavy object. The robotic unit 101 may lift the heavy object up and over the top of the robotic unit, allowing the robotic unit 101 to fit underneath the footprint of the heavy load 141. The robotic unit 101 may also be designed to lift the heavy object to the side, front or back of the robotic unit 101 to allow for greater maneuverability while transporting the heavy object 141. The load bearing support member 108 may contain a lift module 143 as shown in FIG. 6. The electric lift module 143 may include an electronic lift actuator 144 and a lifting motor 145 which lifts the heavy object 141 relative to the wheel 104.

In one aspect of the present invention, the attachment point 130 may be attached to a spacer plate 164 by screwing the attachment point on to spacer plate 164. In some aspects of the present invention the attachment point 130 may contain welded attachment tabs that are secured to the attachment point 130 to the spacer plate 164 using bolts, screws or other coupling mechanisms. The spacer plate 164 may be attached to the top of the thrust bearing 129. The spacer plat may be secured to the thrust bearing using bolts, screws or other coupling mechanisms. In an alternative aspect of the present invention the attachment point 130 may be permanently attached to the thrust bearing 129. In another aspect the load bearing frame 109 and the attachment point 130 are permanently connected to each other by screwing the attachment point on to load bearing frame 109. In some aspects of the present invention the attachment point may contain welded attachment tabs that are secured to the load bearing frame 109 or the thrust bearing 129 using bolts, or screws. In an alternative aspect the load bearing frame 109 and the attachment point 130 may be connected by a coupling mechanism 131 such as interlocking channels, or a channel that slides over an I-bar/beam or H-beam piece on the robot unit. This allows for connecting different sized attachment points 130, creating greater stability and safety when transporting the load.

Referring to FIG. 3 another aspect of the robotic unit is shown. The load bearing frame 109 may have a base portion 150. The base portion 150 of the load bearing frame may include a main sheet. The main sheet may include a first side opposing a second side. The second side may have support bar. The support bar 156 may be located closer to the middle of the second side. The support bar may run the length of main sheet. The support bar may be oriented in the same direction of the axle 132. In other aspects the support bar may run perpendicular to the axle 132. In other aspects the support bar may be oriented in another direction relative to the axle 132. The main sheet 153 may further comprising a coupling mechanism allowing electrical equipment, power equipment or drive components to be coupled to or stabilized with the base frame 150. The steering module 108 or drive module 107 may be coupled to the base portion 150. In one aspect of the present invention the axle 132 is operatively coupled to the base portion 150. The first side may contain one or more bars running the length of the base portion. In some aspects of the present invention, the one or more bars run parallel to the axle 132. The bars may be configured to operatively connect the axle 132 to the base portion 150. In some aspects of the present invention the base portion 150 is attached to the axle 132 and the electrical actuator 134.

In one aspect of the present invention the robotic unit 101 includes at least one gearmotor mounting bracket 162 may be operatively coupled to the base portion 150. The gearmotor mounting bracket 162 may be coupled to the base portion 150 using bolts, screws or any other coupling mechanism. The gearmotor mounting bracket may be configured to hold the drive module 107 or the driving motor 135.

The load bearing frame 109 may include a top portion 151. The top portion 151 of the load bearing frame may include a main sheet. The main sheet may include a first side opposing a second side. In one aspect of the present invention the top portion may contain a coupling mechanism to secured to the load bearing frame 109 to a thrust bearing 129 using bolts, or screws or any other coupling mechanism.

The load bearing frame 109 may contain at least one electronic drawer 160 configured to house at least one electrical component of the robotic transport unit. In one aspect of the present invention the electronic drawer may be comprised of a single sheet. The electronic drawer 160 may be further comprised of side walls. In one aspect of the present invention, the electronic drawer 160 may house the battery 133 to power the robotic unit 101. The electronic drawer may be configured to slide in and out of the load bearing frame 109. The electronic drawer 160 may be coupled to the load bearing frame 109 using metal drawer slides. In one aspect of the present invention the load bearing frame may contain a stopping mechanism such as latches or stoppers or any other stopping mechanism configured to stabilize the electronic drawer 160 to stop the electronic drawer 160 from sliding while the robotic unit 101 is moving. In other aspects of the present invention, the electronic drawer 160 may be stationary and located inside the load bearing frame 109. The electronics drawer may contain a power mechanism such as a button, switch or dial for turning the robotic unit on and off.

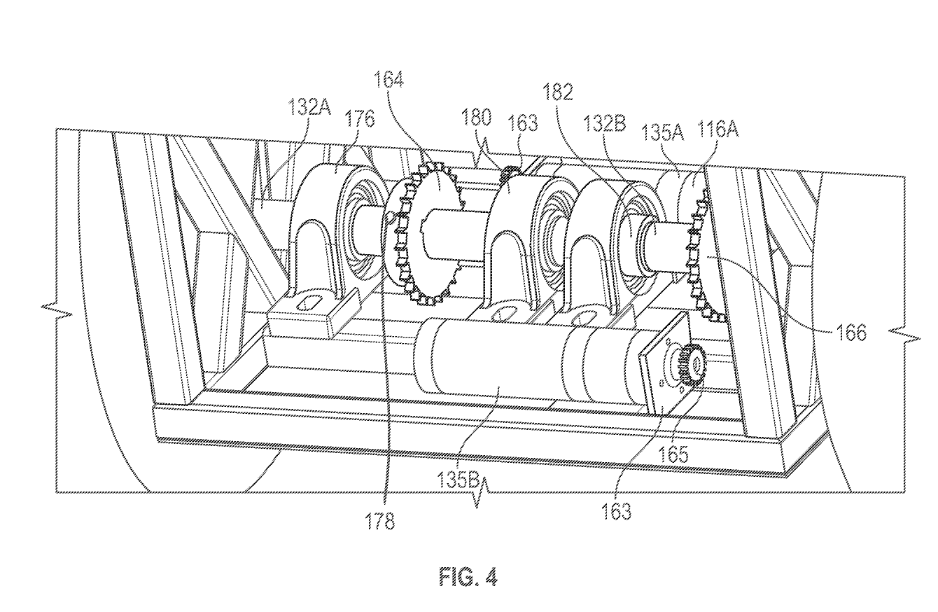

Referring to FIG. 4, an illustrative aspect of the base portion 150 of the load bearing frame 109 is shown, the electronics drawer is removed for illustrative purposes. In one aspect of the present invention axle 132 may be a continuous axle. In other aspects of the present invention the axle may be discontinuous with a first axle 132A connected to wheel 104A and a second axle 132B connected to wheel 104B. In some aspects of the present invention the robotic unit 101 may have two driving motors, a first driving motor 135A and a second driving motor 135B. The first driving motor 135A may be attached to the base portion 150 of the load bearing frame 109 by a first gearmotor mounting bracket 162A. The second driving motor may be attached to the base portion 150 by a second gearmotor mounting bracket 162B. The first driving motor 135A may be connected to a first drive gear sprocket 163. The first drive gear sprocket may be supported by the first gear motor mounting bracket 162A. The first drive gear sprocket 163 may be connected to a second drive gear sprocket 164. The second drive gear sprocket 164 may be connected to a first axle 132A and secured in location relative to first axle 132A using a set screw 178. Similarly, first drive gear sprocket 166 may be secured to second axle 132B using a set screw (not shown). The first gear sprocket 163 may be operably connected to the second drive gear sprocket 164 by a linking mechanism such as a chain, a belt or any other linking mechanism. The first driving motor 135A may be configured to rotate wheel 104A, by rotating the first drive gear sprocket 163. The first drive gear sprocket 163 rotates second drive gear sprocket 164 by the linking mechanism. The second drive gear sprocket 164 then rotates first axle 132A which rotates wheel 104A. The second driving motor 135B may be connected to a third gear sprocket 165. The third gear sprocket 165 may be supported by a second gearmotor bracket 162B. The third gear sprocket 165 may be linked to a fourth gear sprocket 166 by a linking mechanism such as a chain or a belt or any other linking mechanism. The fourth gear sprocket 166 may be connected to the second axle 132B. The second driving motor 135B may be configured to rotate wheel 104B, by rotating the first drive gear sprocket 163. The third drive gear sprocket 165 rotates fourth drive gear sprocket 166 by the linking mechanism. The fourth drive gear sprocket 166 then rotates first axle 132B which rotates wheel 104B.

In some aspects of the present invention, the first driving motor 135A may be configured to rotate wheel 104A in relation to the load bearing frame 109. The second driving motor 135B may be configured to rotate wheel 104B in relation to the load bearing frame 109. The first driving motor 135A and the second driving motor 135B may drive the robotic unit forward by rotating wheel 104A and wheel 104B at the same revolutions per minute (RPM) in a same first direction. The first driving motor 135A and the second driving motor 135B may drive the robotic unit 101 backwards or reverse by rotating wheel 104A and 104B at the same RPMs in a same second direction. When driving motor 135A is rotating wheel 104A at a faster RPM and second driving motor 135B is rotating wheel 104B at a slower RPM the robotic unit 101 may be configured to turn left. When first driving motor 135A is rotating wheel 104A at a slower RPM and second driving motor 135B is rotating wheel 104B at a faster RPM, the robotic unit 101 may be configured to turn right. In some aspects of the present invention the load bearing frame 109 may turn left or right relative to the attachment point 130. In other aspects of the present invention the attachment point 130 may be configured to freely rotate when the robotic unit 101 is turning right or left.

In one aspect, rotation of first axle 132A and second axle 132B in the same or opposite direction at the same or different speed are supported by bearings 176, 180 and 182.

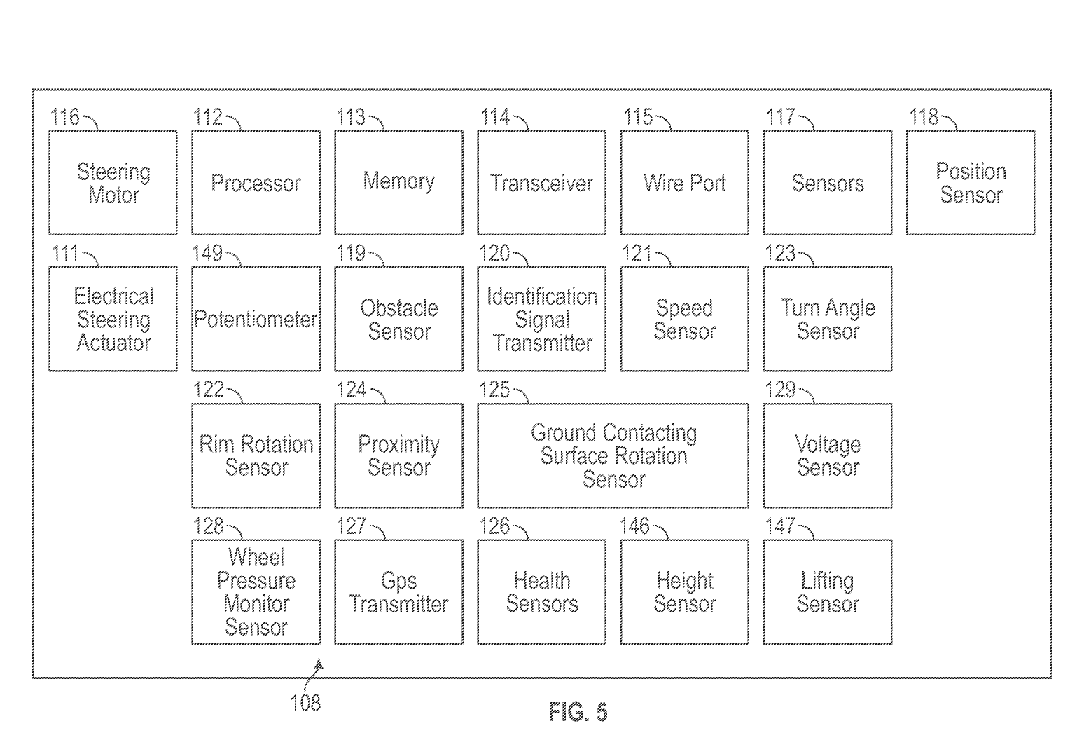

Referring to FIG. 5 of the present invention, the steering module 108 is shown. The steering module 108 may control the direction robotic unit 101 is turning or rotating. The steering module 108 may include a steering motor 116 operatively attached to the wheel and operably configured to turn the wheel relative to the load bearing frame 109. The steering module 108 may be operatively connected to an electronic steering actuator 111 operably configured to turn the wheel relative to the load bearing frame. The steering module 108 may be comprised of one or more processors 112, a memory 113, a transceiver 114 to receive control signals from remote device 102 or send feedback to remote device 102. The steering motor control system 111 may also contain a wire port 115 for a wired connection with remote device 102. The steering motor control system may also house or be operably connected to one or more sensors 117. The one or more sensors may also be housed elsewhere on the robotic unit 101 such as in the drive module 107, in the rim 105, in the ground contacting surface 106, in the load bearing frame 109, in the axle 132, in the attachment point 130. Sensors 117 may also be operable connected to the drive module 107. Sensors 117 may also be operable connected to the drive module, the steering module 108, or the electric lift module 143. In some aspects of the present invention at least one component of the steering module 108 may be housed in the electronics drawer 160.

Processor 112 may comprise one or more general purpose computers, dedicated microprocessors, or other processing devices capable of communicating electronic information. Processor 112 may include one or more application-specific integrated circuits (ASICs), field programmable gate arrays (FPGAs), digital signal processors (DSPs) and any other suitable specific or general purpose processors. In some aspects of the present invention, processor 112 may be housed in the electronics drawer 160.

Memory 113 may store the one or more processor 113 instructions, sensor readings, control system 103 instructions and/or any other appropriate values, parameters, or information utilized by robotic unit 101 during operation. Memory 113 may represent any collection and arrangement of volatile or nonvolatile, local or remote devices suitable for storing data. Examples of memory 113 include, but are not limited to, random access memory (RAM) devices, read only memory (ROM) devices, magnetic storage devices, optical storage devices or any other suitable data storage devices. In some aspects of the present invention, memory 113 may be housed in the electronics drawer 160.

In some aspects of the of the present invention, the robotic unit 101 may contain one or more sensors 117. In some aspects of the present invention, the robotic unit 101 may contain sensors allowing the remote device 102 to determine the position or location of robotic unit 101. These sensors may include at least a position sensor 118, an obstacle sensor 119, or an identification signal transmitter 120. Robotic unit 101 may also contain at least a speed sensor 121, rim rotation sensor 122, a turn angle sensor 123, or a proximity sensor 124, a ground contacting surface rotation sensor 125, wheel pressure monitoring sensor 128, voltage sensors 129. The robotic unit 101 may also include additional health sensors 126 to monitor robotic unit 101. The robotic unit 101 may include a height sensor 146 for determining the height of the heavy object 141 during transport or while lifting or lowering the heavy object 141. The robotic unit 101 may also include lifting sensors 147 to for monitoring whether the robotic unit is lifting or lowering the heavy object 141. The sensors transmit readings to drive module 107, the steering module 108, or the electric lift module 143. The sensors 117 may have the ability to self-calibrate on their own, may re-calibrate when robotic unit 101 is turned on, or may calibrate based on a user command by the remote device 102. In some aspects of the present inventions, at least one sensor 117 may be housed in the electronics drawer 160.

Positioning sensor 118 may represent one or more sensors, detectors, or any other components suitable for determining the location of robotic unit 101. Positioning sensor 118 may include a or a global positioning signal (GPS) transmitter 127 using the Global Navigation Satellite System (GNSS). Positioning sensor 118 may include a camera or other suitable image and/ or video processing components.

Obstacle sensor 119 represents at least one sensor, detector or any other components suitable for determining any obstacles in robotic unit 101 path. Obstacle sensor 119 may include optical sensors, radar sensors, sonar sensors, pressure-sensing sensors, or any other sensors capable of detecting objects.

Proximity sensor 124 represents at least one sensor, detector or any other components suitable for determining robotic unit 101 position relative to other robotic units, remote device 102, the transportation destination, obstacles, or from where transportation started. Proximity sensor 124 may include optical sensors, radar sensors, sonar sensors, pressure-sensing sensors, or any other sensors capable of detecting objects. Proximity sensor 124 may include a camera or other suitable image and/ or video processing components.

Identification signal transmitter 120 represents at least one sensor, transmitter or any other components suitable for determining which robotic unit 101 is communicating with the remote device 102.

Speed sensor 121 represents at least one sensor, detector or any other components suitable for determining the speed of robotic unit 101. Speed sensor 121 may be a hall effect speed sensor, variable reluctance speed sensors, eddy current speed sensors, radar doppler speed sensors, LIDAR speed sensors, accelerometer speed sensors, pitot based speed sensors, pitometer speed sensors, digital magnetic speed sensors.

The rim rotation sensor 122 represents at least one sensor, detector, emitter, receiver or any other components suitable for determining the rotation speed or turn angle of robotic unit 101. The rim rotation sensor 122 sensor may include optical sensors such as a reflective sensor, interruptive sensor, optical encoders or potentiometers 149 or any other components suitable for determining the rotation of the rim. Rim rotation sensor 122 may also include magnetic sensors such as a variable-reluctance sensor, and eddy-current killed oscillator, Wiegand sensors or Hall-effect sensors.

The turn angle sensor 123 represents at least one sensor, detector, emitter, one or more potentiometers 149 or any other components suitable for determining the rotation speed or turn angle of robotic unit. Turn angle sensor 123 may include steering angle sensors, multi-turn position sensor

The ground contacting surface rotation sensor 125 represents at least one sensor, detector, emitter or any other components suitable for determining the rotation speed or turn angle of robotic unit. The ground contacting surface rotation sensor 125 sensor may include optical sensors such as a reflective sensor, interruptive sensor, optical encoders. Ground contacting surface rotation sensor 125 may also include magnetic sensors such as a variable-reluctance sensor, and eddy-current killed oscillator, Wiegand sensors or Hall-effect sensors.

Referring to FIG. 6, one aspect of the drive module 107 is shown. The drive module 107 houses an electronic actuator 134 configured to rotate the wheel 104 relative to the load bearing frame 109 and a driving motor 135 drive module 107 may be comprised of one or more processors 112, a memory 113, a transceiver 114 to receive control signals from remote device 102 or send feedback to remote device 102. The drive module 107 may also contain a wire port 115 and a wire 116 for a wired connection with remote device 102. The drive module may also contain one or more sensors 117. The drive module may also contain chains, rotation motor sprockets and axle sprockets designed to rotate the wheel. The drive module may be located anywhere in the robotic unit 101 such as the load bearing frame 109, the axle 132 or the wheel 104. In one aspect of the present invention, at least one component of the drive module 107 may be housed in the electronics drawer 160.

Referring to FIG. 7, one aspect of the lift module 143 is shown. The lift module 143 houses a electronic lift actuator 144 and a lifting motor 145. The lift module 143 may be comprised of one or more processors 112, a memory 113, a transceiver 114 to receive control signals from remote device 102 or send feedback to remote device 102. The lift module 143 may also contain a wire port 115 and a wire 116 for a wired connection with remote device 102. The lift module 143 may also contain one or more sensors 117. In one aspect of the present invention, at least one component of the lift module 143 may be housed in the electronics drawer 160.

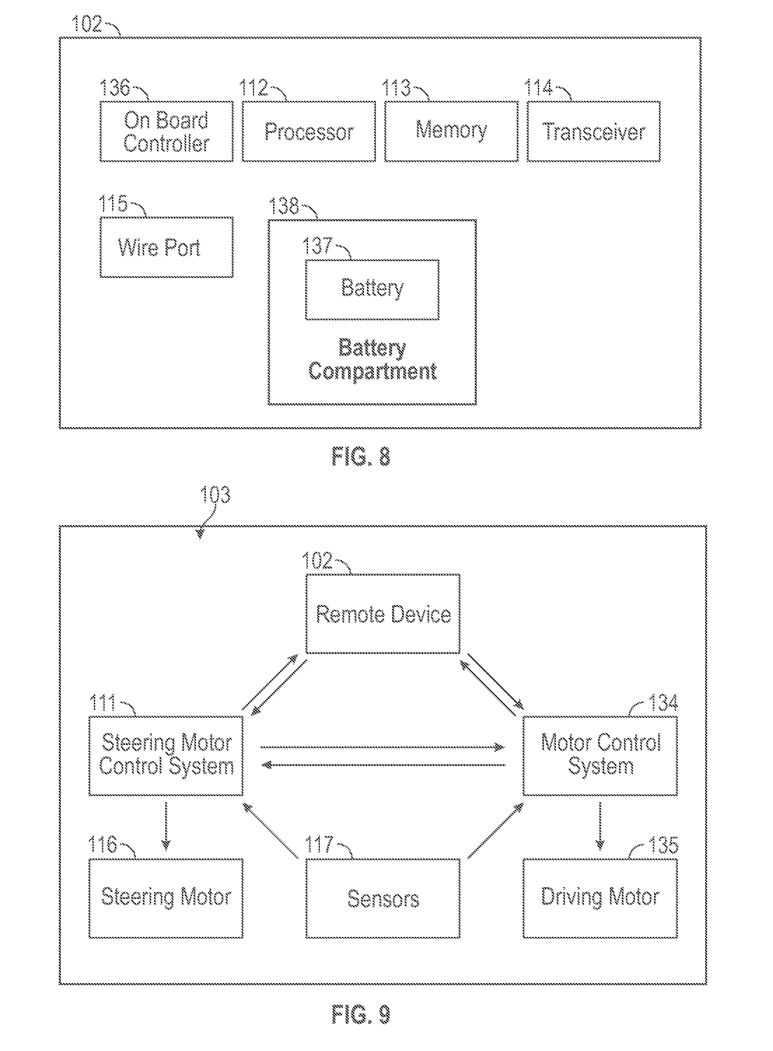

Referring to FIG. 8, the preferred aspect of the remote device 102 is shown. Remote device 102 to control robot unit 101. Remote device 102 may contain an onboard controller 136 configured to control robotic unit 101, a processor 112, a memory 113, a transceiver 114, a wire port 115 for wired communication with the motor control system 134 or the steering motor control system 111, battery 137, or a battery compartment for receiving batteries 138.

The remote device 102 may contain buttons, joysticks, steering wheels, hand throttles, a display monitor, a touch screen, or any other component allowing for movement control of robotic unit 101. The remote device 102 may have charge indicators for the remote device itself and the robotic unit 101. The remote device 102 may be powered by batteries, rechargeable batteries, or another power source. The remote device 102 may also contain status/health indicators showing the connection to one or more robotic units 101 as wells as specific codes for events such as failures. Those specific codes may be color codes, number codes, letter codes or specific messages. In an alternative aspect, the remote device 102 may contain a port to attach a wire to allowing wired communication. In another aspect, the wire may be attached to the remote device allowing for wired communication. The remote device may be a remote controller, a mobile phone, a computer, a tablet or anything else capable of controlling robotic unit 101.

In one aspect of the control system 103, the remote device 102 may communicate certain commands to the drive module 107, the steering module 108, or lift control module 143 such as: target speed; lowest speed; highest speed; steering angle; lowest steering angle; highest steering angle; start command; stop command, a reengage command, a begin lifting command, a stop lifting command, a being lowering command, a stop lowering command, a target height of the heavy object 141, the lowest desired height of the heavy object 141, or the highest desired height of the heavy object 141. The steering module 108 may communicate specific items to the remote device 102 such as: actual speed; actual steering angle; charge; proximity; line of sight; height of the heavy object 141, whether the robotic unit 101 is lifting or lowering the heavy object 101 and health. The sensors 117 may communicate specific data to the drive module 107, steering module 108, or the lift module 143 such as: actual speed; actual steering angle; battery charge; proximity; height of the heavy object 141, line of sight; and health. The steering motor control system 111 may communicate certain commands to the drive module 107 such as: speed, differential speeds and direction. The drive module 107 that may communicate commands to the electrical actuator 134 including rotation speed. The steering module 108 may communicate with the lift module 143 certain commands such as lift the heavy object, stop lifting the heavy object 141, actual height the heavy object 141 needs to be at for transport. The electric lift motor control system may then communicate with the lift motor 145 to begin lifting the heavy object 141 relative to the wheel 104. This communication pattern allows the multi-directional transport system 100 to have greater efficiency, maneuverability and safety.

Referring to FIG. 9, one aspect of the control system 103 is shown. The remote device 102 communicates wirelessly with either the steering module 108, the drive module 107, or the lift module 143. Different methods for wireless communication may be used including Bluetooth, Radio Frequency, or WIFI. In another aspect control system 103 may use wired communication. Sensors 117 send data to either the steering module 108, the drive module 107, or the lift module 143. The drive module 107 controls the driving motor 135. The steering module 108 controls the steering motor 116. The lift module 143 controls the lifting motor 145. Different methods of wired communication may be used between the operator controller and the unit controller including controller area network (CAN); ethernet; In one aspect the remote device and the unit controller communicate using CAN through a single twisted pair cable. If more than one robotic unit 101 is used for transporting the heavy object, the robotic units 101 may be designed to move in sync with one another in order to transport a load efficiently using the control system.

In one aspect of the present invention, the multi-directional system 100 can implement safety measures. One such safety implementation is the emergency shut off. The remote device 102 will send a stop command if it loses connection with one or more robots, no robotic unit 101 has a line of sight to the remote device, or when the proximity area is breached. The robotic unit 101 may also stop if a connection with the remote device 102 is lost.

Referring to FIG. 10, one aspect of the method of transporting a heavy object using the multi-directional transport system 100 is shown. First the at least one robotic unit 101 is attached to a heavy object 139 (Step 200). The attachment may be by use of the attachment point 130.

Next, commands are communicated to the at least one robotic unit 101 for transporting the heavy object 139 (Step 205). The commands may be sent by a remote device 102 using a wired or wireless connection with the robotic unit 101. The commands may be sent to the motor control system 134 through control system 103 as shown in FIG. 6. Lastly, the drive module 107 begins to operably drive the rim 105 (Step 210).

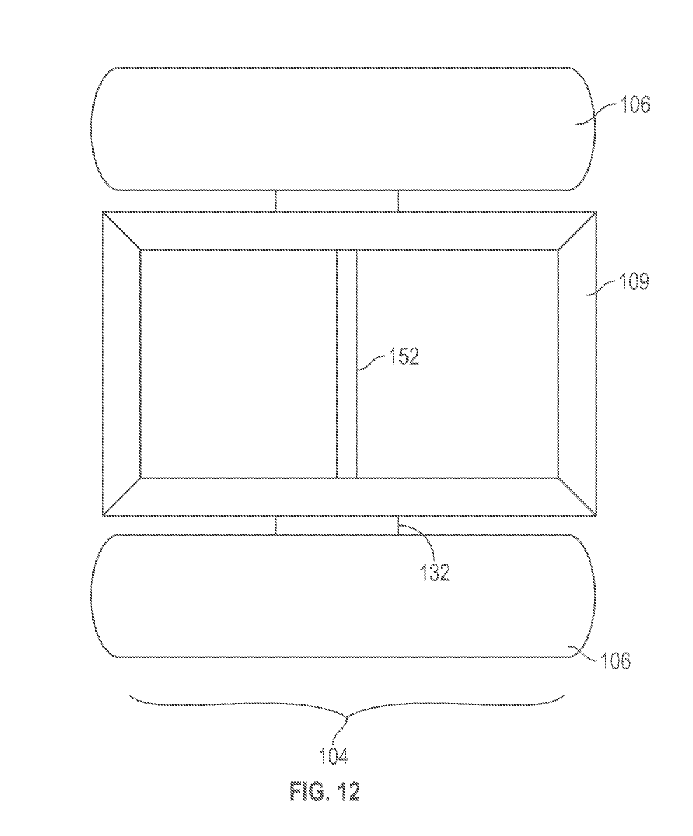

Referring to FIG. 11, one aspect of the method of transporting an object using a multi-directional transport system 100 shown. First the at least one robotic unit 101 is attached to a heavy object 139 (Step 200). The attachment may be by use of the attachment point 130. In an alternative aspect, the attachment step 150, may include lifting the heavy object 141 to a desired height. Next, the remote device 102 communicates with the steering module 108 (Step 202). Next, the steering module 108 communicates with the sensors 117 to gather sensor readings (Step 204). The steering module 108 then sends the senor data to the remote device 102 (Step 205). The steering module 108 then causes the steering motor 116 to steer the at least one robotic unit 101 (Step 206). The steering module 108 may be operatively connected to the drive module 107 and may communicate certain commands (Step 208). The drive module 107 begins rotating the wheel 104(Step 210).

In an alternative aspect of the present invention, the method may further include the remote device 102 communicates with the steering module 108 directions while transporting the heavy load 141. The method may further include the multi-directional transport system 101 reaches the desired location. Finally, the method may further include terminating transport and lowering the heavy load 141 to the ground or a desired height. In an alternative aspect of the present invention, the multi-direction transport system 100 uses four robotic units 101 to transport the load. Each robotic unit 101 may be comprised of three wheels 104. One of the wheels may smaller or larger than the other two. In alternative aspects the third wheel may be a stabilizing wheel, or a caster wheel. The robotic unit 101 has a steering module 108 that responds to commands given by the remote device 102 and gives feedback it receives from the sensors 117 to the remote device 102. The steering module 108 may send commands to the drive module 107 to rotate the wheel 104.

In another aspect of the present invention, the multi-direction transport system 100 uses four robotic units 101, comprising of two wheels 104, to transport the load. The robotic unit 101 has a steering module 108 that responds to commands given by the remote device 102 and gives feedback it receives from the sensors 117 to the remote device 102. The steering module 108 may send commands to the drive module 107 to rotate the rim 105. The four robotic units may be designed to move in synchronization with each other while transporting the load to the desired location. In some aspects of the present invention, the units may use crab steering allowing the robotic units 101 place near the front of the load 141 to move or turn in a different direction than the robotic units 101 placed in the back of the heavy load 141.

In another aspect of the present invention, the multi-direction transport system 100 uses four robotic units, each comprising of four or more wheels 104, to transport the load. The robotic unit 101 has a steering module 108 and a drive module 107 that responds to commands given by the remote device 102 and gives feedback it receives from the sensors 117 to the remote device 102. The steering module 108 may send commands to the driving module 107 to rotate the rim 105. The four robotic units may be designed to move in synchronization with each other while transporting the load to the desired location. In some aspects of the present invention, the units may use crab steering allowing the robotic units 101 place near the front of the load 141 to move or turn in a different direction than the robotic units 101 placed in the back of the heavy load 141.

In additional aspects of the present invention the multi-directional transport system 100 may use more than four robotic units 101 to transport the heavy load controlled by the same remote device. The robotic units may have one or more wheels 104 attached to ground contacting surface 106. The use of multiple robotic units allows for better weight distribution while transporting the heavy load.

In another aspect of the present invention the robotic units 101 are turned on, the robotic unit connects with the remote device 102. Every time a robotic unit 101 connects with the remote device 102, the control system 103, synchronizes the newly added robotic unit 101 with the existing robotic units 101 already connected to the remote device 102 allowing the robotic units to move in unison.

In alternative aspects of the robotic multi-directional transport system 100, only one robotic unit 101, controlled by the remote device 102, is used to transport the load in the front of the load while one or more non-robotic units are used to aid in transporting the moving object. In another aspect, two robotic units 101, controlled by a remote device 102, may be used while transporting the load along with one or more nonrobotic units 140. The two robotic units may be designed to move in synchronization with each other while transporting the load to the desired location. In some aspects of the present invention, the units may use crab steering allowing the robotic units 101 place near the front of the load 141 to move or turn in a different direction than the robotic units 101 placed in the back of the heavy load 141. In another aspect, three robotic units 101, controlled by a remote device 102, may be used while transporting the load along with one or more nonrobotic units 140. The three robotic units may be designed to move in synchronization with each other while transporting the load to the desired location. In some aspects of the present invention, the units may use crab steering allowing the robotic units 101 place near the front of the load 141 to move or turn in a different direction than the robotic units 101 placed in the back of the heavy load 141. In other aspects, one robotic unit 101 may be the master unit controlled by remote device 102 and the one more other robotic units 101 and or nonrobotic units 140 may be slave units. In yet another aspect of the present invention, at least one robotic unit 101 may be used with at least one electric pulley.

Referring to FIG. 12 another aspect of the robotic unit is shown. Axle 132 housed partially in the load bearing frame. The base portion of the load bearing frame may have a support bar 152. The support bar may run the length of the base portion 150. In some aspects of the present invention the support bar 152 may run parallel to the axle 132.

The invention is not to be limited to the particular aspects described herein. In particular, the invention contemplates numerous variations in robotic multi-direction transportation. The foregoing description has been presented for purposes of illustration and description. It is not intended to be an exhaustive list or limit any of the invention to the precise forms disclosed. It is contemplated that other alternatives including the number of wheels, the types of sensors, the number of axles, the number of drive motors or exemplary aspects are considered included in the invention. The description is merely examples of aspects, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of aspects for implementing the multi-direction transport system invention and is not intended to be limiting in scope. The various aspects of the disclosure are set forth in the written description and accompanying drawings, wherein objects, features, function, and advantages of one aspect of the disclosure, whether presented pictorially or in writing, is intended to apply to other aspects of the disclosure. Reference numerals specific to a particulate aspect or drawing(s) are intended for illustration and are to apply to all relevant or similar aspects across the breadth of the disclosure and drawings. The following claims set forth a number of the aspects of the invention disclosed with greater particularity.

What is claimed is:

1. A multi-directional transport system for moving heavy objects comprising:
at least one robotic unit further comprising:
at least one wheel having a ground contacting surface, and a rim supporting the ground contacting surface;
a load bearing frame operatively attached to the wheel;
an attachment point configured to secure the robotic unit to a heavy load;
a drive module comprised of a driving motor operatively attached to the wheel and operably configured to rotate the wheel;
wherein the drive module is further comprised of an electrical actuator operably configured to rotate the wheel;
a steering module further comprised of a steering motor operatively attached to the wheel and operatively configured to turn the wheel relative to the attachment point;
wherein the steering module is further comprised of an electrical steering actuator operably configured to turn the wheel relative to the attachment point;
a control system operably connected to the robotic unit, the control system configured to provide one or more operational commands to the at least one robotic unit.

2. The multi-directional transport system of claim 1, wherein the electrical actuator comprises a motor control system housed within the electrical actuator configured to control operation of the electrical actuator with the one or more operational commands.

3. The multi-directional transport system of claim 1, wherein robotic unit further comprises a thrust bearing attached to the load bearing frame configured to rotate the load bearing frame in relation to the attachment point.

4. The multi-directional transport system of claim 1, wherein the load bearing frame further comprises an electronics drawer configured to store at least one electrical component and a battery.

5. The multi-directional transport system of claim 1, wherein the load bearing frame is attached to an axle connected rim, wherein the electronic actuator rotates the axle in relation to the load bearing frame.

6. The multi-directional transport system of claim 1, wherein the load bearing frame further comprises a steering motor attached in part to an axle connected to the load bearing support and the wheel, wherein the steering motor rotates the axle in relation to the attachment point.

7. The multi-directional transport system of claim 1, wherein at least 2 synchronized robotic units are configured together to transport the load, at least 3 synchronized robotic units are configured together to transport the load, or at least 4 synchronized robotic units are configured together to transport the load.

8. A multi-directional transport system for moving heavy objects comprising:
at least one robotic unit further comprising:
a first wheel and a second wheel;
the first wheel having a first ground contacting surface, a first rim supporting the first ground contacting surface and the second wheel having a second ground contacting surface, a second rim supporting the second ground contacting surface;
an axle attached to the first wheel and the second wheel;
a load bearing frame operatively attached to the axle;
an attachment point configured to secure the robotic unit to a heavy load;
a drive module comprised of a driving motor operatively attached to the first wheel and the second wheel and operably configured to rotate the first wheel and the second wheel;
wherein the drive module is further comprised of an electrical actuator operably configured to rotate the first wheel and the second wheel;
a steering module further comprised of a steering motor operatively attached to the wheel and operatively configured to turn the wheel relative to a load bearing frame;
wherein the steering module is further comprised of an electrical steering actuator operably configured to turn the wheel in relation to the attachment point;
a control system operably connected to the robotic unit, the control system configured to provide one or more operational commands to the at least one robotic unit.

9. The multi-directional transport system of claim 8, wherein at least 2 synchronized robotic units are configured together to transport the load, at least 3 synchronized robotic units are configured together to transport the load, or at least 4 synchronized robotic units are configured together to transport the load.

10. The multi-directional transport system of claim 8, wherein the robotic unit further comprises a thrust bearing connected to the load bearing frame and configured to rotate the load bearing frame in relation to the attachment point.

11. The multi-directional transport system of claim 10 wherein the robotic unit further comprises a spacer plate attached to the thrust bearing and the attachment point.

12. The multi-directional transport system of claim 8, wherein electrical actuator is housed within the load bearing frame and operably connected to the axle.

13. The multi-directional transport system of claim 12 wherein the load bearing frame has a base portion, wherein the base portion is attached to the axle and the electrical actuator.

14. The multi-directional transport system of claim 12 wherein the load bearing frame further comprises an electronics drawer configured to store at least one electrical component and a battery.

15. A method for moving objects using a multi direction transport system, comprising:
providing at least one robotic unit to transport an object, wherein the robotic unit comprises at least one wheel having a rim and a ground contacting surface connected to the rim for transporting the object, wherein the robotic unit further comprises an electrical actuator, the electrical actuator being operably configured to rotate the ground contacting surface, a load bearing frame secured to the rim, and a attachment point configured to attach the robotic unit to a load;
attaching the attachment point of the robotic unit to an underside of a load-bearing portion of the object;
communicating electronic commands to the at least one robotic unit; and
actuating the electrical actuator with the electronic commands to operably drive the ground contacting surface for transporting the object.

16. The method of claim 15, further comprising:
monitoring a status of the robotic unit with a remote device, wherein the status includes one or more of battery power, motor actuation, wheel rotation, wheel turn angle, speed, proximity, and power status.

17. The method of claim 15, further comprising:
steering the wheel with a steering motor, wherein the steering motor rotates the wheel in relation to the attachment point.

18. The method of claim 15, further comprising:
driving the wheel with the driving motor wherein the driving motor rotates the wheel in relation to the load bearing frame.

19. The method of claim 18 further comprising:
terminating the driving of the wheel once the robotic unit has reached a target destination.

20. The method of claim 15 further comprising:
syncing the robotic unit drive module to a second drive module of a second robotic unit attached to the load.
